(19) United States
(12) Patent Application Publication
(10) Pub. No.: US 2023/0419092 A1
(43) Pub. Date: Dec. 28, 2023

(54) CROSSBAR ARRAYS IMPLEMENTING TRUTH TABLES

(71) Applicant: INTERNATIONAL BUSINESS MACHINES CORPORATION, Armonk, NY (US)

(72) Inventor: Charles Mackin, San Jose, CA (US)

(21) Appl. No.: 17/847,955

(22) Filed: Jun. 23, 2022

(51) Int. Cl. G06N 3/063; G06N 3/08

(52) U.S. Cl. CPC G06N 3/0635; G06N 3/08

(57) ABSTRACT

A method for preparing a trained crossbar array of a neural network is provided. The method includes feeding an input portion of a predetermined truth table into a computer simulation of a crossbar array, and generating analog output values for the input portion of the truth table based on simulated weights. The method further includes calculating a loss value from each of the analog output values and expected values for an output portion of the truth table, and adjusting the simulated weights based on the calculated loss values. The method further includes refeeding the input portion of the predetermined truth table into the computer simulation and recalculating the output values using the adjusted simulated weights until the analog output values produce the expected values for the output portion of the truth table within a predefined margin of error.

### BACKGROUND

The present invention generally relates to the use of crossbar arrays and neural networks for implementing complex truth tables, and more particularly to implementing crossbar arrays and neural networks in place of field programmable gate arrays (FPGAs) to provide complex truth tables and additional neural network functionality.

A way to design a combinational logic circuit is to interconnect logic gates, but digital logic circuits constructed using discrete logic gates have fixed functions defined at the time of manufacturing. A field-programmable gate array (FPGA) is an integrated circuit designed to be configured by a customer after manufacturing. FPGAs contain an array of programmable logic blocks, and a hierarchy of reconfigurable interconnects allowing blocks to be wired together. Before the FPGA can be used it would be programmed to implement a desired function. A programmable logic array (PLA) is a kind of programmable logic device used to implement combinational logic circuits. FPGAs can be used for the development of deep neural networks.

Combinational Logic Circuits are made up from basic logic NAND, NOR or NOT gates that are “combined” or connected together to produce more complicated switching circuits. These logic gates are the building blocks of combinational logic circuits, including FPGAs.

A truth table is a mathematical table used in logic, where each input variable has its own column, and each output variable also has its own column, where the output column(s) show the results of the logical operation that the table represents. Each row of the truth table contains one possible configuration of the input variables and the output value(s).

### SUMMARY

In accordance with an embodiment of the present invention, a method for preparing a trained crossbar array of a neural network is provided. The method includes feeding an input portion of a predetermined truth table into a computer simulation of a crossbar array, and generating analog output values for the input portion of the truth table based on simulated weights. The method further includes calculating a loss value from each of the analog output values and expected values for an output portion of the truth table, and adjusting the simulated weights based on the calculated loss values. The method further includes refeeding the input portion of the predetermined truth table into the computer simulation and recalculating the output values using the adjusted simulated weights until the analog output values produce the expected values for the output portion of the truth table within a predefined margin of error.

In accordance with an embodiment of the present invention, a computer program product for training a crossbar array of a neural network, the computer program product comprising: one or more computer readable storage media, and program instructions collectively stored on the one or more computer readable storage media is provided. The program instructions include program instructions for feeding an input portion of a predetermined truth table into a computer simulation of a crossbar array, and generating analog output values for the input portion of the truth table based on simulated weights. The program instructions further include program instructions for calculating a loss value from each of the analog output values and expected values for an output portion of the truth table, and adjusting the simulated weights based on the calculated loss values. The program instructions further include program instructions for refeeding the input portion of the predetermined truth table into the computer simulation and recalculating the output values using the adjusted simulated weights until the analog output values produce the expected values for the output portion of the truth table within a predefined margin of error.

In accordance with an embodiment of the present invention, a computer system for preparing a trained crossbar array of a neural network is provided. The computer system includes one or more processors, and computer memory electronically coupled to the processors. The computer system includes a computer simulation stored in the computer memory, including a model of a crossbar array, wherein the computer simulation is configured to receive an input portion of a predetermined truth table; generate analog output values for the input portion of the truth table based on simulated weights; calculate a loss value from each of the analog output values and expected values for an output portion of the truth table; adjust the simulated weights based on the calculated loss values; and refeed the input portion of the predetermined truth table into the computer simulation and recalculate the output values using the adjusted simulated weights until the analog output values produce the expected values for the output portion of the truth table within a predefined margin of error.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a cross-sectional view showing a crossbar array of a neural network being trained with a truth table, in accordance with an embodiment of the present invention;

FIG. 2 is a cross-sectional view showing a crossbar array of a neural network generating the output of a truth table, in accordance with an embodiment of the present invention;

FIG. 3 is a top view showing a crossbar array of a neural network implementing inverters at the output to generate digital ones and zeros from digital input, in accordance with an embodiment of the present invention;

FIG. 4 is a block/flow diagram showing generation of adjusted simulated weights through computer simulation, in accordance with an embodiment of the present invention;

FIG. 5 is a block/flow diagram showing training of a crossbar array, in accordance with an embodiment of the present invention; and

FIG. 6 is a computer system for generation of adjusted simulated weights through computer simulation, in accordance with an embodiment of the present invention.

### DETAILED DESCRIPTION

Various embodiments relate to implementing crossbar arrays and neural networks in place of field programmable gate arrays (FPGAs) to provide complex truth tables and additional neural network functionality. Crossbar arrays can be used for machine learning and learning digital logic truth tables, where the crossbar array(s) can be trained or programmed on truth table data sets. A truth table can include an input portion that provides inputted values for training the neural network, and an output portion that represents the expected values generated at the output of the neural network. Not all combinations of input values or output values may be expected for a particular environment. Learning digital logic truth tables, however, may require 100% accuracy. In various embodiments, combinational logic blocks can be replaced with crossbar arrays.

In various embodiments, there can be a noise margin at the output of a crossbar array based neural network. Inverters and/or sense amplifiers can be used to output digital logic of zeros and ones despite variations and noise in the neural network output signals. This can provide for both digital input and digital output. Because of noise, a logic high signal at the output of the driving device may arrive with a lower voltage at the input of the receiving device than would trigger a high digital value. The noise margin is the amount of noise that could be added to a worst-case output such that the signal can still be interpreted as a valid input. The I/O noise margins (low and high), NM L and NM H, refer to the ability of a logic gate (e.g., inverter) to accommodate input noise without producing a faulty logic output. In various embodiments, the inverter can have a noise margin of less than 50% of Vdd (drain voltage), for example, 2% to 49%. In various embodiments, there can be two or more inverters in series.

In various embodiments, a neural network trained on truth tables can be reset in the field and reprogrammed, either through retraining or through direct programming of new weights. This can provide flexibility in that the crossbar arrays can be used for artificial neural network (ANN) applications and to implement re-programmable digital logic, like an FPGA, with the same neural network device package.

In various embodiments, training for a predetermined truth table can be executed in a simulation environment using a model that mimics signal noise for a crossbar array. The training can be done offline using graphics processing units (GPUs). The weight values generated by the computer simulation and model can be directly loaded into the nonvolatile memory cells of the crossbar array(s).

In various embodiments, the neural network can have variable layer size and depth to provide training to 100% accuracy, where the exact expected output for each inputted truth table is generated by the crossbar array every time.

Exemplary applications/uses to which the present invention can be applied include, but are not limited to: used for, FPGAs, datacenters, medical devices, automotive applications, edge computing, etc.

It is to be understood that aspects of the present invention will be described in terms of a given illustrative architecture; however, other architectures, structures, components, and process features and steps can be varied within the scope of aspects of the present invention.

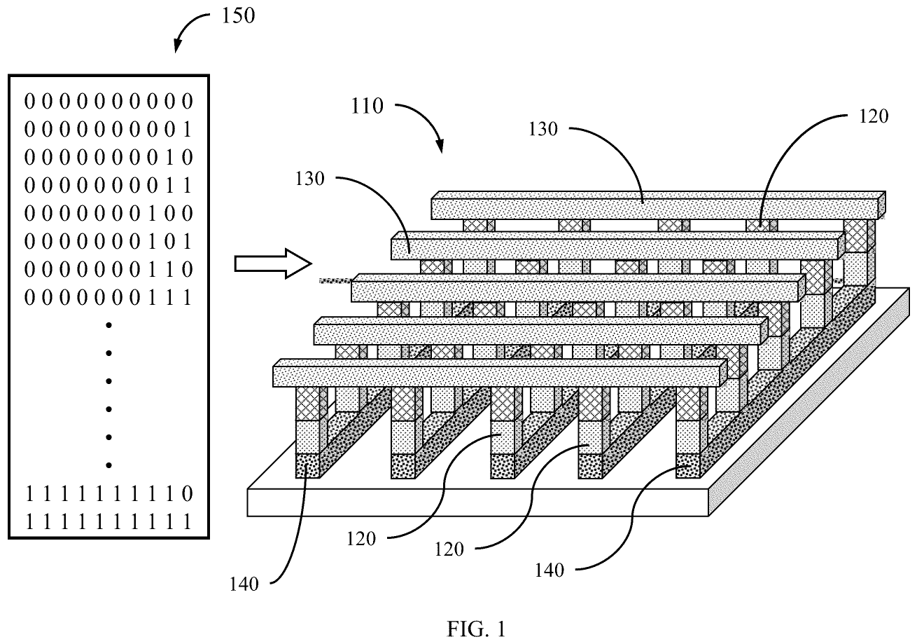

Referring now to the drawings in which like numerals represent the same or similar elements and initially to FIG. 1, FIG. 1 is a cross-sectional view showing a crossbar array of an artificial neural network (ANN) being trained with a truth table, in accordance with an embodiment of the present invention.

In one or more embodiments, a crossbar array 110 can be implemented using nonvolatile memory devices 120 electrically coupled between crossing conductive lines, where the nonvolatile memory devices 120 can be analog nonvolatile memory devices 120 configured to store a range of weights, where multiple bits of weight data can be stored per cell/NVM device. Memory elements with low cycle-to-cycle variability or noise in its stored weight value can be used to store multiple bits of weight information. The upper conductive lines 130 can be perpendicular to the lower conductive lines 140 or cross at an angle less than 90 degrees. By using these non-volatile memory (NVM) arrays to store the weights and performing neural network computations directly with the memory elements that store the weights, computation can be done in parallel and energy and latency costs associated with data movement can be reduced.

In one or more embodiments, predetermined truth table(s) 150 can be used to establish the weights of the stored by the nonvolatile memory devices 120 of the crossbar array 110 through training. The crossbar arrays may be trained directly using the truth table as an input, or a computer simulation that models the crossbar array(s) can be used to achieve trained weights and the weights can be programmed into the crossbar array(s). The number of elements in each input set can determine the number of input nodes of the neural network and the number of weights used for calculating the output set of values, which can include one or more values representing one or more states (e.g., 1 or 0), where the number of output values is determined by the truth table.

In various embodiments, the size and complexity of the truth table input and output portions can determine the size and complexity of the neural network and the crossbar array(s) utilized by the neural network.

In various embodiments, the nonvolatile memory devices 120 retain the weights for the crossbar array 110 learned through the training or programming. Weights can be constructed using one or more non-volatile memories. For example, phase change material (PCM) conductance would be positive, so negative weights could be constructed using differential pairs of conductances, such that the total weight, W=G+-G−. Then the weight is positive if G+>G− or negative if G+<G−. A weight can also be constructed using even more conductances, such as W=F*(G+-G−)+g+-g−, where F*is some fixed scaling factor to increase the overall dynamic range of the weight(s) that can be represented.

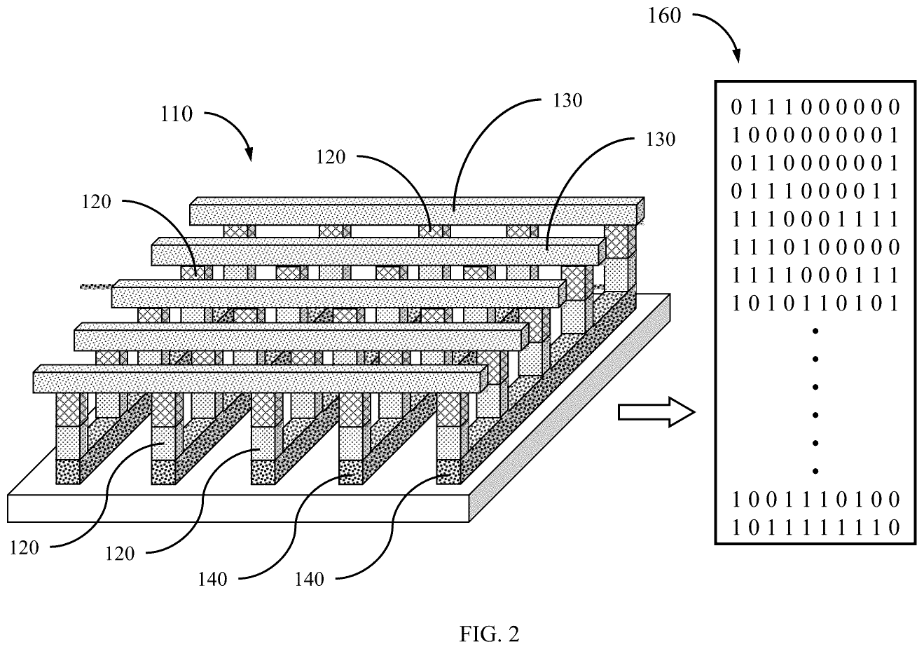

FIG. 2 is a cross-sectional view showing a crossbar array of a neural network generating the output of a truth table, in accordance with an embodiment of the present invention.

In one or more embodiments, the known values of the input portion of a truth table 150 can be inputted to a neural network having one or more crossbar arrays 110, and the output table(s) 160 generated by the neural network can be compared to the intended output defined by the output portion of the truth table. The truth table inputs 150 and truth table outputs 160 can be used to train the neural network to have learned the truth tables with 100% accuracy. The training samples can cover 100% or less of the input/output value combinations, for example, where not all combinations are possible in the environment in which the neural network is eventually implemented. An actual circuit may only encounter some fraction of the exhaustive list of possible combinations. For truth tables, all output values can be known (ground truth) for all input combinations, so the neural network may be trained to 100% accuracy without overfitting.

In various embodiments, the training can be conducted through software simulation of the neural network and crossbar arrays, which includes noise simulation in the model. The weights produced by training the simulation can then be programmed/stored into actual crossbar arrays.

In various embodiments, the truth table output(s) 160 generated by the neural network can have one or more values for the outputs representing different logical states. The truth table input(s) 150 and truth table output (s) 160 can be Boolean truth tables or more complex truth tables. This could also be used for logic with more than two states (e.g., 3-valued, multi-level, etc.). The truth table output generated by a crossbar array may be sent to other digital circuitry or may be input to another crossbar array.

In various embodiments, test sets are not utilized to determine the accuracy of the neural network, as the known values of the inputted truth table has a one-to-one mapping to the known values of the truth table output, with an intended 100% accuracy, so overtraining would not be an issue.

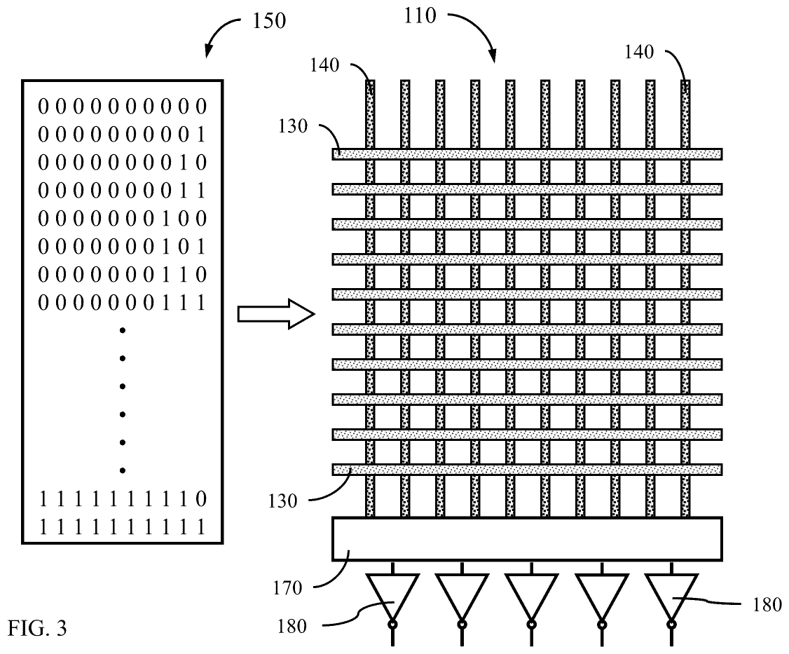

FIG. 3 is a top view showing a crossbar array of a neural network implementing inverters at the output to generate digital ones and zeros from digital input, in accordance with an embodiment of the present invention.

In one or more embodiments, outputs can be digitized and processed by digital circuits. Because crossbar arrays perform computations on analog signals, output may be converted into a digital form that can be interpreted as a result or transmitted to the next crossbar array/layer of the neural network. An inverter 180 can be electrically coupled to each crossbar output to generate a voltage corresponding to a digital one or zero to avoid intervening voltage values that could be misinterpreted. The inverter 180 can generate a digital output from the crossbar output even with noise at the crossbar output signal. In various embodiments, the crossbar array 110 can generate output signals/values within a noise margin. The inverter 180 can convert the output value within the noise margin into a digital one or zero.

In various embodiments, and interface 170 can be electronically coupled and in electrical communication with the crossbar array 110 to sum the values produced by the analog nonvolatile memory devices 120 and apply a suitable activation function, f, to the summed output, where f can be a non-linear activation function. The interface 170 can perform a transformation on the analog values outputted by the crossbar array 110, where the transformation can map one representation of an input to another. With analog weights and signals, errors in the crossbar arrays due to noise, nonlinearity, and variability can accumulate from array to array for neural network layers. The output representation can be propagated as inputs to another crossbar array. In various embodiments, the non-linear activation function can be, for example, rectified linear unit (ReLU), a sigmoid function, or hyperbolic tangent (tanh(x)).

Multiply and Accumulation (MAC) unit can be used for vector-matrix multiplication. The multiply and accumulate hardware/unit/circuit/operation can compute the product of two numbers and adds that product to an accumulator.

A MAC can be used in conventional ANN applications and for truth table applications, where ANNs (and therefore MACs) can be used to learn digital logic truth tables.

In one or more embodiments, the crossbar array(s) can replace combinational logic blocks that would be used in FPGAs.

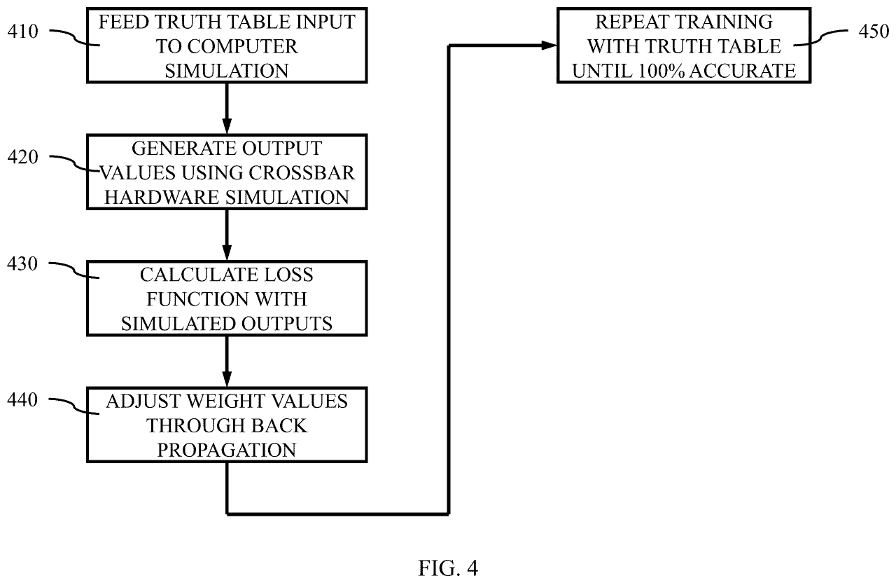

FIG. 4 is a block/flow diagram showing generation of adjusted simulated weights through computer simulation, in accordance with an embodiment of the present invention.

In one or more embodiments, the a computer simulation can generate weights for a crossbar array of a neural network, where the computer simulation models the crossbar array and training of the neural network through back propagation.

At block 410, an input portion of a predetermined truth table can be fed into a computer simulation of a crossbar array. The input values can be digital ones and zeros. In various embodiments, the weights of the computer simulation can be initialized with random weight values before training to avoid issues that could arise if the initial weights were all set to one, zero, or the same values. The output portion of a predetermined truth table can be fed into a computer simulation for loss calculations.

At block 420, the computer simulation can generate analog output values for the input portion of the truth table based on simulated hardware and simulated weights for a crossbar array. Values outputted by the computer simulation can be analog signals generated by matrix—vector multiplication (MVM).

At block 430, a loss value can be calculated from each of the analog output values and expected values from the output portion of the truth table using a loss function. The output values can be analog or digital values. In various embodiments, the loss function can be mean square error (MSE).

At block 440, the simulated weights can be adjusted based on the calculated loss values. The weights stored by the computer simulation of the crossbar array(s) can be adjusted using the loss values computed from the outputted values and output portion of the truth table using back propagation.

At block 450, the training can be repeated by refeeding the input portion of the predetermined truth table into the computer simulation and recalculating the output values using the adjusted simulated weights until the analog output values produce the expected values for the output portion of the truth table within a predefined margin of error. In supervised learning, the network can be trained to make accurate predictions by iteratively updating weight matrices until the output provides the correct values. The original truth table can be fed into the neural network (NN), for example, in a range of about 10 times to about 1,000,000 times. In various embodiments, training can be repeated until 100% of the outputs have converged to within some predetermined error margin, for example, a 0% error margin, where the output values match the output portion of the truth table 100%.

In one or more embodiments, the trained weights of the simulated crossbar array and the neural network can be implemented in the field for intended operation using the truth tables used for training.

In one or more embodiments, a crossbar array can be retrained with new simulated weights and results by feeding a new truth table with known output values into the computer simulation. Prior to inputting the new truth table, the weights of the crossbar array may be reset in a manner appropriate for the type of non-volatile memory utilized in the crossbar array (e.g., phase change, ferroelectric, magnetic, etc.).

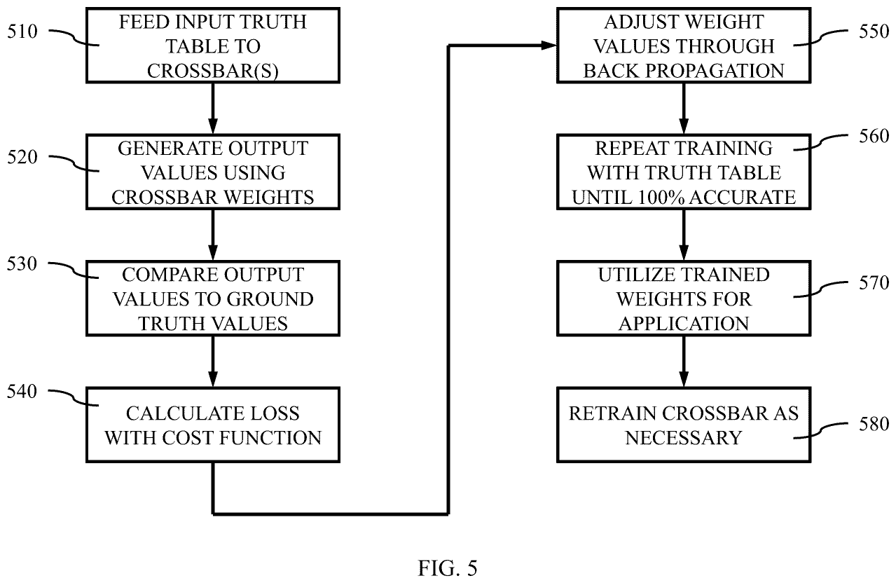

FIG. 5 is a block/flow diagram showing training of a crossbar array, in accordance with an embodiment of the present invention.

In one or more embodiments, the neural network and crossbar array(s) can be trained 500 using a predetermined truth table representing inputs and expected outputs (e.g., ground truth values).

At block 510, the predetermined truth table can be fed into the input nodes of a neural network to train one or more crossbar arrays that will store the learned weights. The input values can be digital ones and zeros. In various embodiments, the crossbar array(s) can be initialized with random weight values before training to avoid issues that could arise if the initial weights were all set to one, zero, or the same values. In various embodiments, a plurality of crossbar arrays may store the learned weights.

At block 520, the neural network can output the result values for the inputted truth table generated from the weights stored by the crossbar array. Values outputted by the crossbar array can be analog signals, whereas outputs generated by inverters or sense amplifiers can be digital signals.

At block 530, the outputted values can be compared to the known/expected values for the inputted truth table. The output values can be analog or digital values depending on whether the output values are output by the crossbar array(s) or an inverter.

At block 540, a loss can be computed from the outputted values compared to the inputted truth table. In various embodiments, the analog values of the weights can be used for calculating the loss and training the weights, where the analog signal values can be compared to analog values that would produce the expected digital output. In various embodiments, the digital values can be directly used for calculations by the loss function.

In various embodiments, the loss function can be mean square error (MSE), where one or more crossbar arrays can be trained to be 100% accurate through minimizing the loss function for a training dataset.

At block 550, the weights stored by the crossbar array can be adjusted using the loss values computed from the outputted values and inputted truth table. The amount that the learned weights can be adjusted may be based on the loss values.

At block 560, the training can be repeated by refeeding the truth table into the neural network and recalculating the output values using the adjusted weights in the crossbar array. In various embodiments, the original truth table can be fed into the neural network (NN), for example, in a range of about 10 times to about 1,000,000 times. In various embodiments, training can be repeated until 100% of the outputs have converged to within some error margin, for example, as determined by the inverters.

At block 570, the trained weights of the crossbar array and the neural network can be implemented in the field for intended operation using the truth tables used for training.

At block 580, the crossbar array can be retrained by feeding a new truth table with known output values into the neural network and crossbar array. Prior to inputting the new truth table the weights of the crossbar array may be reset in a manner appropriate for the type of non-volatile memory utilized in the crossbar array (e.g., phase change, ferroelectric, magnetic, etc.).

In various embodiments, a complete set of new weights trained on another crossbar array may be stored in the field implemented neural network by rewriting the implemented crossbar array. Memories can be programmed or reprogrammed by applying voltage pulses of varying durations and currents. These can be used to RESET the memory. Additional pulses can then be used to incrementally adjust the conductance of the nonvolatile memory devices of the crossbar array.

In one or more embodiments, the neural network and crossbar array(s) can have a reset feature and accompanying circuitry to erase or reset the weights stored in the nonvolatile memory devices 120 of the crossbar array 110, so the nonvolatile memory devices 120 of the crossbar array 110 can be reprogrammed or retrained with new weights in the field. Reprogramming of the nonvolatile memory devices 120 of the crossbar array 110 can entail storing pretrained weights determined offline into the nonvolatile memory devices 120 of the crossbar array 110, whereas retraining can involve reentering/inputting new truth table(s) to generate a new set of weights in the field, where the new truth table(s) can be different from original truth tables used for a previous training.

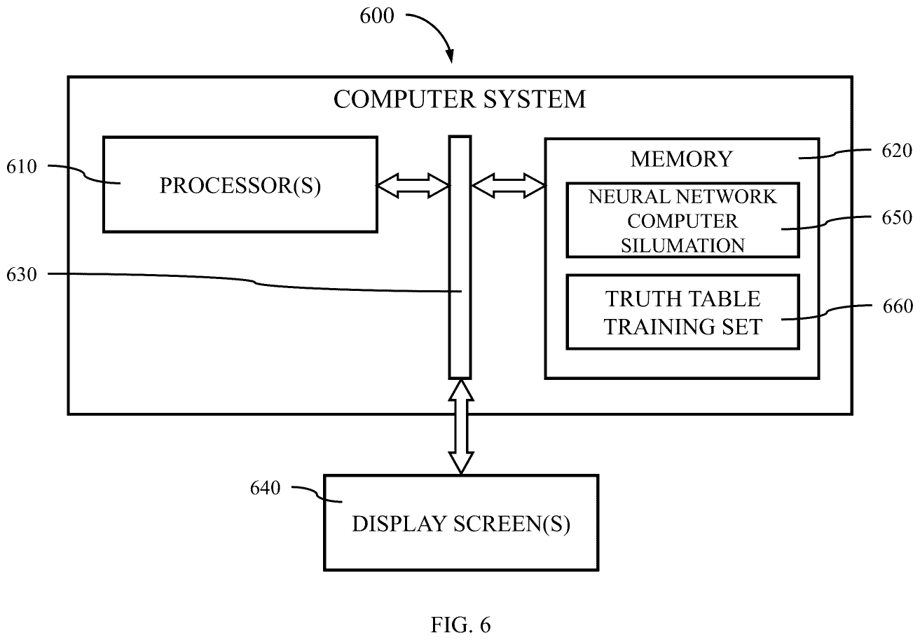

FIG. 6 is a computer system for generation of adjusted simulated weights through computer simulation, in accordance with an embodiment of the present invention.

In one or more embodiments, one or more processors 610 (e.g., central processing units (CPUs), graphical processing units (GPUs), etc.) can be electronically coupled and in electrical communication with computer memory 620 through a bus 630. In various embodiments, a display screen 640 can be electronically coupled and in electrical communication with the one or more processors 610 and the computer memory 620 through the bus 630.

In various embodiments, a computer simulation 650 that models the crossbar array(s) can be stored in the computer memory 620. In various embodiments, a truth table 660 that can be used for training a neural network through the simulation can be stored in the computer memory 620.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer method for preparing a trained crossbar array of a neural network, comprising:
feeding an input portion of a predetermined truth table into a computer simulation of a crossbar array;
generating analog output values for the input portion of the truth table based on simulated weights;
calculating a loss value from each of the analog output values and expected values for an output portion of the truth table;
adjusting the simulated weights based on the calculated loss values; and
refeeding the input portion of the predetermined truth table into the computer simulation and recalculating the output values using the adjusted simulated weights until the analog output values produce the expected values for the output portion of the truth table within a predefined margin of error.

2. The computer method of claim 1, wherein each simulated analog output value includes an error that is less than 49% of Vdd.

3. The computer method of claim 2, wherein the predefined margin of error is 0%.

4. The computer method of claim 3, wherein the loss value is calculated using a mean square error (MSE) loss function.

5. The computer method of claim 4, further comprising programming one or more crossbar arrays with the adjusted simulated weights, wherein the programmed one or more crossbar arrays mimic a field programmable gate array (FPGA).

6. The computer method of claim 5, further comprising resetting the weights of the one or more crossbar arrays.

7. The computer method of claim 6, further comprising reprogramming the one or more crossbar arrays with different weights to mimic a different field programmable gate array (FPGA).

8. A computer program product for training a crossbar array of a neural network, the computer program product comprising: one or more computer readable storage media, and program instructions collectively stored on the one or more computer readable storage media, the program instructions comprising: program instructions for:
feeding an input portion of a predetermined truth table into a computer simulation of a crossbar array;
generating analog output values for the input portion of the truth table based on simulated weights;
calculating a loss value from each of the analog output values and expected values for an output portion of the truth table;
adjusting the simulated weights based on the calculated loss values; and
refeeding the input portion of the predetermined truth table into the computer simulation and recalculating the output values using the adjusted simulated weights until the analog output values produce the expected values for the output portion of the truth table within a predefined margin of error.

9. The computer program product of claim 8, wherein each analog output value includes an error that is less than 49% of Vdd.

10. The computer program product of claim 9, wherein the predefined margin of error is 0%.

11. The computer program product of claim 10, wherein the loss value is calculated using a mean square error (MSE) loss function.

12. The computer program product of claim 11, further comprising programming one or more crossbar arrays with the adjusted simulated weights, wherein the programmed one or more crossbar arrays mimic a field programmable gate array (FPGA).

13. The computer program product of claim 12, further comprising resetting the weights of the one or more crossbar arrays, and reprogramming the one or more crossbar arrays with different weights to mimic a different field programmable gate array (FPGA).

14. A computer system for preparing a trained crossbar array of a neural network, comprising:
one or more processors;
computer memory electronically coupled to the processors;
a computer simulation, including a model of a crossbar array, wherein the computer simulation is configured to:
receive an input portion of a predetermined truth table;
generate analog output values for the input portion of the truth table based on simulated weights;
calculate a loss value from each of the analog output values and expected values for an output portion of the truth table;
adjust the simulated weights based on the calculated loss values; and
refeed the input portion of the predetermined truth table into the computer simulation and recalculate the output values using the adjusted simulated weights until the analog output values produce the expected values for the output portion of the truth table within a predefined margin of error.

15. The computer system of claim 14, further comprising a digital logic truth table stored in the computer memory as a training dataset.

16. The computer system of claim 15, wherein each simulated analog output values includes an error that is less than 49% of Vdd.

17. The computer system of claim 16, wherein the loss value is calculated using a mean square error (MSE) loss function.

18. The computer system of claim 16, wherein the predefined margin of error is 0%.

19. The computer system of claim 18, further comprising one or more crossbar arrays and an inverter at each output of the one or more crossbar arrays that produces a digital one or zero output from a noisy input signal.

20. The computer system of claim 19, wherein the one or more crossbar arrays are configured to be reset and reprogrammed by applying a voltage pulse.
